(19) United States
(12) Patent Application Publication
(10) Pub. No.: US 2006/0103770 A1
(43) Pub. Date: May 18, 2006

(54) Storage capacitor with hole and liquid crystal display using the same

(75) Inventors: Chao Yi Hung, Miao-Li (TW); Hung Yu Chen, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/273,322

(22) Filed: Nov. 14, 2005

(30) Foreign Application Priority Data
Nov. 12, 2004 (TW) 93134591

(51) Int. Cl. G02F 1/1343

(52) U.S. Cl. 349/38

(57) ABSTRACT

A liquid crystal display includes a plurality of pixel regions (3), each of which includes a substrate portion (39) and a storage capacitor (37) arranged on the substrate portion. The storage capacitor includes a first capacitor electrode (38), an insulating layer (36) formed on the first capacitor electrode, and a second capacitor electrode (34) positioned on the insulating layer. At least one through hole (380) is arranged in at least one of the first and second capacitor electrodes. With the edge effect of the through hole(s) of the capacitor electrode(s), the capacitance of the storage capacitors can be increased significantly. Therefore, each of the storage capacitors can have a high capacitance without reducing the aperture ratio of the liquid crystal display.

### FIELD OF THE INVENTION

The present invention relates to storage capacitors, and particularly relates to a storage capacitor used in a liquid crystal display (LCD).

### BACKGROUND

An active matrix LCD generally includes a plurality of pixel regions defined by a plurality of gate lines and a plurality of data lines that cross each other. A plurality of thin film transistors (TFTs) are arranged at intersections of the gate lines and the data lines. Each pixel region includes a pixel electrode, which is controlled by a corresponding TFT.

When a signal is applied to a TFT, a corresponding pixel electrode is activated; that is, a voltage is applied to the pixel electrode. In order to obtain a high display effect, the pixel electrode must be maintained at a constant voltage until a next signal is applied to the TFT. For maintaining the voltage of the pixel electrode, a storage capacitor is needed.

Referring to FIG. 6, this shows a pixel region of a conventional LCD. The pixel region 2 includes a pixel electrode 20, a plurality of data lines 23 and gate lines 28, a TFT 200, and a storage capacitor 27. The data lines 23 cross the gate lines 28 to define the pixel region 2. The TFT 200 includes a gate electrode, a source electrode, and a drain electrode respectively connected to one of the gate lines 28, one of the data lines 23, and the pixel electrode 20. The TFT 200 acts as a switch for turning on and turning off the storage capacitor 27.

Referring to FIG. 7, this shows a cross-section of the storage capacitor 27. The storage capacitor 27 is arranged on a glass substrate 29, and includes a first capacitor electrode (the gate line) 28, a first insulating layer 26 arranged on the glass substrate 29 and the first capacitor electrode 28, and a second capacitor electrode 24 positioned on the first insulating layer 26 over the first capacitor electrode 28. A second insulating layer 22 is formed on the second capacitor electrode 24. The pixel electrode 20 is arranged on the second insulating layer 22, and is electrically connected to the second capacitor electrode 24 at a contact hole 220.

In order to achieve a high display effect, the storage capacitor 27 should maintain a constant voltage applied on the pixel electrode 20. Therefore, the storage capacitor 27 must have a certain capacitance value. Since the storage capacitor 27 is equivalent to a capacitor with two parallel planes, the following capacitance formula is applicable:

$${C}_{ST} = \frac{ɛ \cdot A}{d}$$

where “C_{ST}” denotes the storage capacitance value; “ε” denotes the dielectric constant of the first insulating layer 26 between the first capacitor electrode 28 and the second capacitor electrode 24; “A” denotes the effective area of the first capacitor electrode 28 and the second capacitor electrode 24; and “d” denotes the thickness of the first insulating layer 26 between the first capacitor electrode 28 and the second insulating layer 24. Therefore, the capacitance of the storage capacitor 27 is directly proportional to the effective area “A,” and inversely proportional to the thickness “d.”

For a constant thickness “d,” the only way to increase the capacitance of the storage capacitor is to increase the effective area “A.” However, if the effective area “A” is increased, an aperture ratio of the pixel region 2 is reduced. This can significantly limit the display quality of the liquid crystal display.

What is needed, therefore, is a thin film transistor which can have a large capacitance while not reducing the aperture ratio of a corresponding liquid crystal display.

### SUMMARY

In a first preferred embodiment, a storage capacitor includes a first capacitor electrode, an insulating layer formed on the first capacitor electrode, and a second capacitor electrode positioned on the insulating layer. At least one of the first and second capacitor electrodes has at least one through hole.

In a second preferred embodiment, a liquid crystal display includes a plurality of pixel regions, each of which includes a substrate portion and a storage capacitor arranged on the substrate portion. The storage capacitor includes a first capacitor electrode, an insulating layer formed on the first capacitor electrode, and a second capacitor electrode positioned on the insulating layer. At least one through hole is defined in at least one of the first and second capacitor electrodes.

In the storage capacitor of the above-described preferred embodiments, at least one of the first and second capacitor electrodes has at least one through hole. With the edge effect of the through hole(s) in the capacitor electrode(s), the capacitance of the storage capacitor is increased significantly. That is, the capacitance of the storage capacitor can be increased without increasing areas of the capacitor electrodes. Furthermore, the through hole(s) can improve an aperture ratio of the pixel region having the storage capacitor.

Other advantages and novel features will become more apparent from the following detailed description when taken in conjunction with the accompanying drawings, in which:

### BRIEF DESCRIPTION OF THE DRAWINGS

FIG. 1 is a schematic, top view of a pixel region of an LCD according to a first preferred embodiment of the present invention;

FIG. 2 is a schematic, cross-sectional view taken along line II-II of FIG. 1;

FIG. 3 is a schematic, top view of a pixel region of an LCD according to a second preferred embodiment of the present invention;

FIG. 4 is schematic, a top view of a pixel region of an LCD according to a third preferred embodiment of the present invention;

FIG. 5 is schematic, a schematic, cross-sectional view of a pixel region of an LCD according to a fourth preferred embodiment of the present invention;

FIG. 6 is a schematic, top view of a pixel region of a conventional LCD; and

FIG. 7 is a schematic, cross-sectional view taken along line VI-VI of FIG. 5.

### DETAILED DESCRIPTION OF PREFERRED EMBODIMENTS

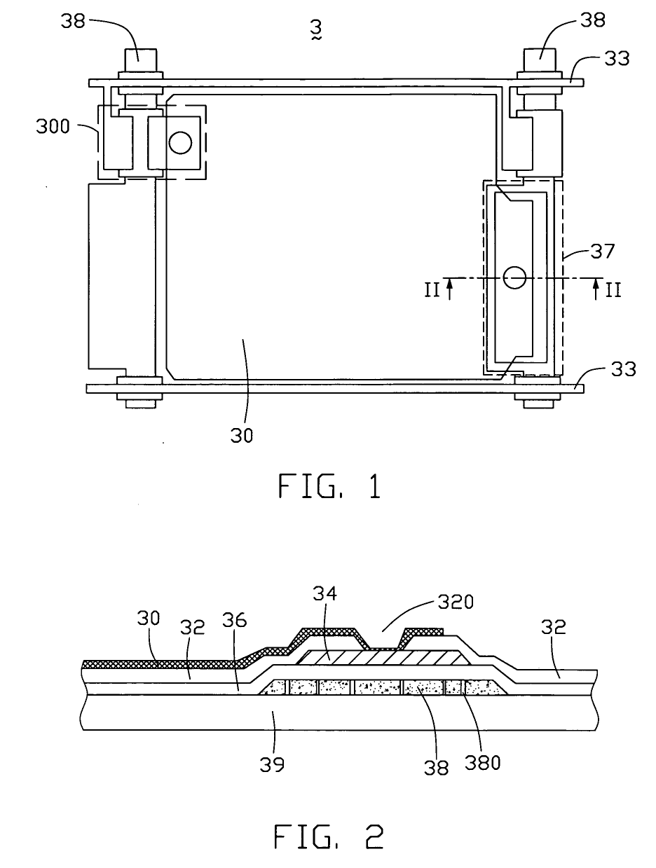

Referring to FIG. 1, this shows a pixel region of an LCD according to the first preferred embodiment of the present invention. The pixel region 3 includes a pixel electrode 30, a plurality of data lines 33 and gate lines 38, a TFT 300, and a storage capacitor 37. The data lines 33 cross the gate lines 38 to define the pixel region 3. The TFT 300 includes a gate electrode, a source electrode, and a drain electrode respectively connected to one of the gate lines 38, one of the data lines 33, and the pixel electrode 30. The TFT 300 acts as a switch for turning on and off the storage capacitor 37.

Referring to FIG. 2, this shows a cross-section of the storage capacitor 37. The storage capacitor 37 is arranged on a glass substrate 39, and includes a first capacitor electrode (the gate line) 38, a first insulating layer 36 arranged on the glass substrate 39 and the first capacitor electrode 38, a second capacitor electrode 34 positioned on the first insulating layer 36 over the first capacitor electrode 38, and a second insulating layer 32 formed on the second capacitor electrode 34. The pixel electrode 30 is arranged on the second insulating layer 32 and electrically connected to the second capacitor electrode 34 at a contact hole 320. The first capacitor electrode 38 includes a plurality of through holes 380 defined therein.

Because of the through holes 380 in the first capacitor electrode 38, and because the first capacitor electrode 38 has a thickness not substantially different from that of the insulating layer 36, the storage capacitor 37 is not an ideal parallel plate capacitor. According to electrostatics theory, the charge density of the first capacitor electrode 38 at the edges of the through holes 380 is greater than that of other portions of the first capacitor electrode 38. This is known as the edge effect. Therefore if the first capacitor electrode 38 has a same area as the first capacitor electrode 28 of the above-described conventional storage capacitor 27, and if a same voltage is applied to the capacitor electrodes 38, 28, the quantity of electric charge on the first capacitor electrode 38 is much more than that of the electric charge on the first capacitor electrode 28.

The capacitance formula C=q/V is applicable, where “C” denotes the capacitance of a capacitor, “q” denotes the quantity of electric charge on one electrode of the capacitor, and “V” denotes the voltage applied on the capacitor. Therefore, the capacitance of the capacitor is directly proportional to the quantity of the electric charge “q,” and inversely proportional to the voltage “V” applied on the capacitor. In the above description, the quantity of the electric charge on the first capacitor electrode 38 is much more than that of the electric charge on the conventional first capacitor electrode 28. Accordingly, the capacitance of the storage capacitor 37 is greater than that of the conventional storage capacitor 27.

As described above, with the edge effect of the through holes 380 of the first capacitor electrode 38, the capacitance of the storage capacitor 37 is increased greatly. That is, the capacitance of the storage capacitor 37 can be increased without increasing areas of the first and second capacitor electrodes 38, 34. Furthermore, the through holes 380 can improve the aperture ratio of the pixel region having the storage capacitor 37. Therefore, the LCD can have a corresponding improved aperture ratio.

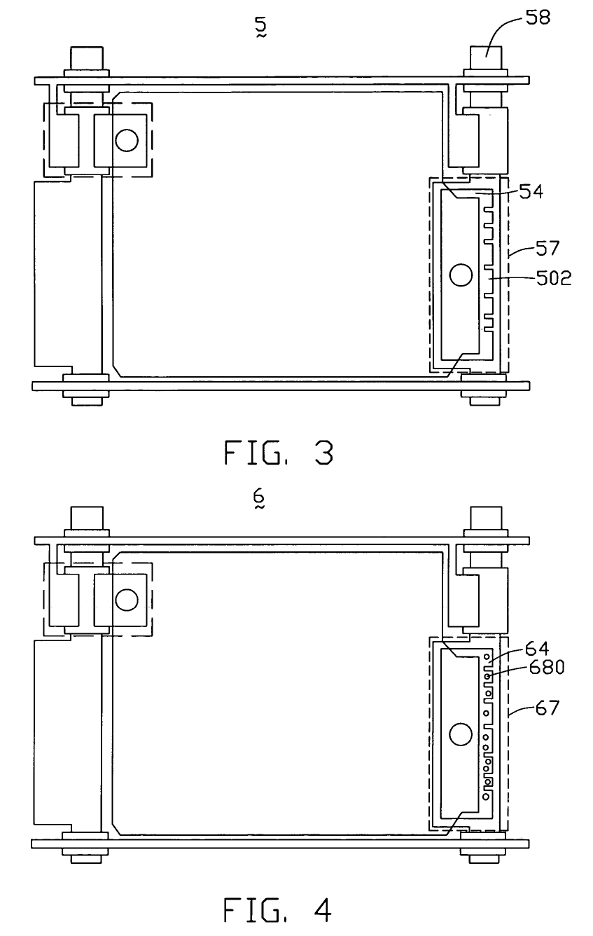

Referring to FIG. 3, this shows a pixel region of an LCD according to the second preferred embodiment of the present invention. The pixel region 5 is similar to the above-described pixel region 3 of the first preferred embodiment. However, unlike with the pixel region 3, the pixel region 5 further includes a plurality of protrusions 502 arranged at one long side of a second capacitor electrode 54 of a storage capacitor 57. The protrusions 502 are connected with each other by a main body of the second capacitor electrode 54. The pixel region 5 includes a plurality of gaps at the long side of the second capacitor electrode 54, the gaps interleaving the protrusions 502.

Each protrusion 502 and a first capacitor electrode 58 cooperatively define a sub-capacitor. That is, the storage capacitor 57 is formed by a plurality of sub-capacitors connected in parallel with each other. Accordingly, the capacitance of the storage capacitor 57 is greater than that of the storage capacitor 37. Furthermore, light beams can pass through the gaps. Accordingly, an aperture ratio of the pixel region 5 is increased.

Referring to FIG. 4, this shows a pixel region of an LCD according to the third preferred embodiment of the present invention. The pixel region 6 is similar to the above-described pixel region 5 of the second preferred embodiment. However, unlike with the pixel region 5, the pixel region 6 further includes a plurality of through holes 640 positioned in a second capacitor electrode 64 of a storage capacitor 67.

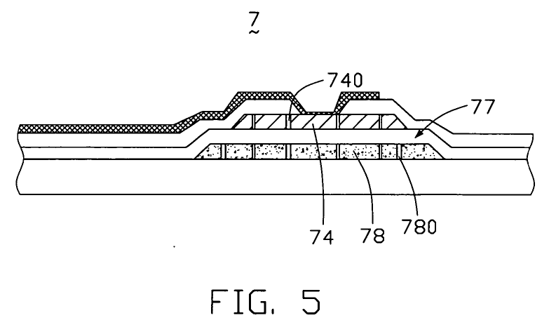

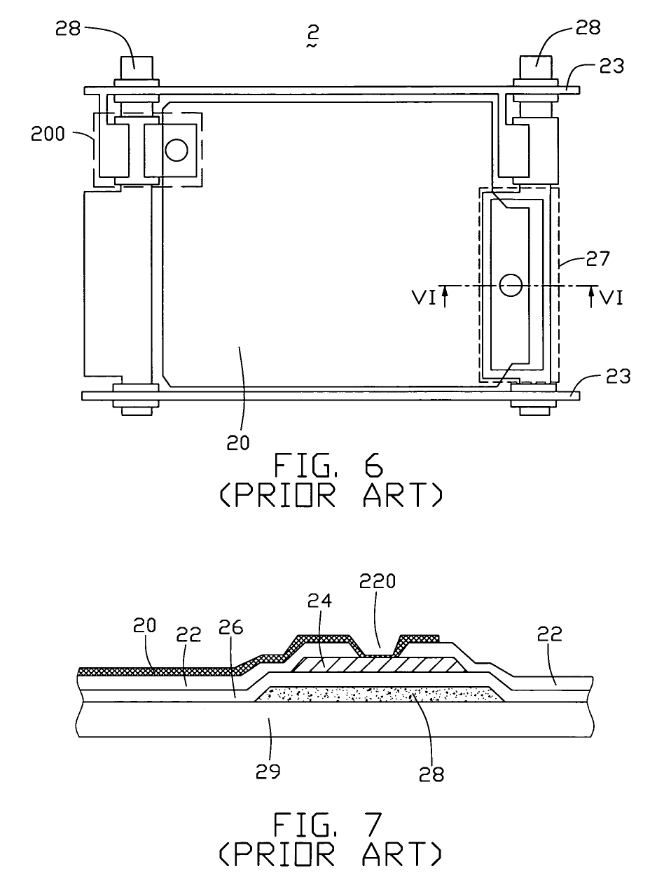

Referring to FIG. 5, this shows a pixel region of an LCD according to the fourth preferred embodiment of the present invention. The pixel region 7 is similar to the above-described pixel region 3 of the first preferred embodiment. However, in the pixel region 7, a plurality of through holes 780 positioned in a first capacitor electrode 78 of a storage capacitor 77, and a plurality of through holes 740 positioned in a second capacitor electrode 74 of the storage capacitor 77. Further some of the through holes 740 and the through holes 780 are correspondingly arranged.

Similar to the through holes 380 of the first preferred embodiment, with the edge effect of the through holes 640 of the second capacitor electrode 64, the capacitance of the storage capacitor 67 is increased greatly. That is, the capacitance of the storage capacitor 67 can be increased without increasing an area of the second capacitor electrode 64. Furthermore, the through holes 640 can improve the aperture ratio of the pixel region 6 having the storage capacitor 67. Moreover, light beams can pass through gaps between protrusions of the storage capacitor 67. Therefore, the LCD can have a corresponding improved aperture ratio.

It is to be understood that the storage capacitor of the present invention is not limited in the above-described preferred embodiments. For example, in the pixel region 3 of the first preferred embodiment, the first capacitor electrode 38 and the second capacitor electrode 34 can be made of the same material or different materials. Any of such materials may include transparent conductive material; for example, indium tin oxide (ITO), indium zinc oxide (IZO), and so on. In other examples, in the pixel region 5 of the second preferred embodiment, instead of having the protrusions 502, the first capacitor electrode 58 of the storage capacitor 57 may have a plurality of protrusions arranged at one long side thereof. In such case, the pixel region 5 includes a plurality of gaps at the long side of the first capacitor electrode 58, the gaps interleaving the protrusions. Further, the storage capacitor 57 may have both the protrusions 502 and the protrusions of the first capacitor electrode 58. Still further, the protrusions 502 and/or the protrusions of the first capacitor electrode 58 may be trapezoidal, triangular, or have another suitable shape or shapes.

It is to be further understood that even though numerous characteristics and advantages of various embodiments of the present invention have been set forth in the foregoing description, together with details of the structures and functions of the embodiments, the disclosure is illustrative only, and changes may be made in detail to the full extent indicated by the broad general meaning of the terms in which the appended claims are expressed.

What is claimed is:

1. A storage capacitor, comprising:
a first capacitor electrode;
an insulating layer formed on the first capacitor electrode; and
a second capacitor electrode positioned on the insulating layer;
wherein at least one of the first and second capacitor electrodes comprises at least one through hole.

2. The storage capacitor as recited in claim 1, wherein at least one of the first and second capacitor electrodes further comprises a plurality of protrusions.

3. The storage capacitor as recited in claim 1, further comprising a plurality of gaps provided at one edge of at least one of the first and second capacitor electrodes.

4. The storage capacitor as recited in claim 1, wherein the first and second capacitor electrodes are made of a same material.

5. The storage capacitor as recited in claim 4, wherein the first and second capacitor electrodes are made of a transparent conductive material.

6. The storage capacitor as recited in claim 5, wherein the first and second capacitor electrodes are made of indium tin oxide and/or indium zinc oxide.

7. A liquid crystal display comprising a plurality of pixel regions, each of which comprises a substrate portion and a storage capacitor arranged on the substrate portion, the storage capacitor comprising:
a first capacitor electrode;
an insulating layer formed on the first capacitor electrode; and
a second capacitor electrode positioned on the insulating layer;
wherein at least one through hole is arranged in at least one of the first and second capacitor electrodes.

8. The liquid crystal display as recited in claim 7, wherein at least one of the first and second capacitor electrodes further comprises a plurality of protrusions.

9. The liquid crystal display as recited in claim 7, further comprising a plurality of gaps provided at one edge of at least one of the first and second capacitor electrodes.

10. The liquid crystal display as recited in claim 7, wherein the first and second capacitor electrodes are made of a same material.

11. The liquid crystal display as recited in claim 10, wherein the first and second capacitor electrodes are made of a transparent conductive material.

12. The liquid crystal display as recited in claim 11, wherein the first and second capacitor electrodes are made of indium tin oxide and/or indium zinc oxide.

13. The liquid crystal display as recited in claim 7, wherein each pixel region further comprises a second insulating layer formed on the second capacitor electrode.

14. The liquid crystal display as recited in claim 13, wherein each pixel region further comprises a pixel electrode positioned on the second insulating layer.

15. The liquid crystal display as recited in claim 14, wherein the pixel electrode is connected to the second capacitor electrode at a contact hole formed in the second insulating layer.
